(19) United States
(12) Patent Application Publication
(10) Pub. No.: US 2016/0318384 A1
(43) Pub. Date: Nov. 3, 2016

(54) POWERTRAIN WITH A VARIABLE-SPEED TRANSMISSION DEVICE, PARTICULARLY FOR HYBRID VEHICLE

(71) Applicant: IFP ENERGIES NOUVELLES, Rueil-malmaison (FR)

(72) Inventor: Stéphane VENTURI, ROIFFIEUX (FR)

(21) Appl. No.: 15/105,733

(22) PCT Filed: Nov. 26, 2014
(86) PCT No.: PCT/EP2014/075701

§ 371 Date: Jun. 17, 2016

(30) Foreign Application Priority Data
Dec. 17, 2013 (FR) 13 62747

(51) Int. Cl. B60K 6/365; F16H 37/04; B60K 6/383; F16H 3/72

(52) U.S. Cl. CPC B60K 6/365; F16H 3/725; F16H 37/04; B60K 6/383; F16H 2037/047; F16H 2200/2007; F16H 2200/2071; F16H 2200/2087; F16H 2200/2064; Y10S 903/911; Y10S 903/913; F16D 43/00

(57) ABSTRACT

The present invention relates to a powertrain for a hybrid type motor vehicle comprising a driving/receiving machine (20), a thermal engine (10), a speed variation device (14) including an engine epicyclic gear train (24) with a sun gear (34) and a crown (44), each connected to engine shaft (12) by a controlled clutch (26, 28) and to a fixed part (42) of the powertrain by a one-way clutch (30, 32) and a planet gear carrier (48), another machine epicyclic gear train (58) comprising a sun gear (56), a crown (66) and a planet gear carrier (60) connected to a device (79) for motion transmission to a drive axle (16), and a rotating motion transmission track for the link between the engine shaft and the motion transmission device. The invention, motion transmission track (90, 124) comprises a controlled link (80, 94, 134) between engine shaft (12) and at least one of elements (48, 56, 60, 66) of one of epicyclic gear trains (24, 58).

### CROSS REFERENCE TO RELATED APPLICATIONS

Reference is made to PCT Application PCT/EP2014/075701 filed Nov. 26, 2014, and French Patent Application No. 13/62.747 filed Dec. 17, 2013, which are incorporated herein by reference in their entirety.

### BACKGROUND OF THE INVENTION

1. Field of the Invention

The present invention relates to a powertrain having a variable-speed transmission, in particular for a hybrid vehicle.

2. Description of the Prior Art

As is known, a hybrid vehicle comprises a powertrain which uses, alone or in combination, a traction/propulsion drive, an internal-combustion thermal engine with a variable-speed transmission and/or a driving/receiving machine such as a rotary electric machine connected to an electric source, such as one or more batteries.

This combination affords the advantage of optimizing the performance of this vehicle, notably by reducing the discharge of emissions to the atmosphere and by decreasing the fuel consumption.

Thus, when the vehicle is to be driven with a high torque over a wide speed range while limiting exhaust gas and noise generation, as in an urban site, the electric machine is preferably used for driving this vehicle.

On the other hand, the thermal engine is used for driving this vehicle for uses where a high driving power and a wide operating range are required.

As French patent application No. 2,955,165 filed by the applicant describes a motor vehicle powertrain comprising a thermal engine having a shaft connected to a variable-speed transmission including an epicyclic gear train with a sun gear and a crown each connected to the shaft of the thermal engine by a controlled clutch and to a fixed part of the powertrain by a one-way automatic clutch, and a planet gear carrier transmitting the speed variation to the drive axle of the vehicle through a transmission track.

In order to increase the speed variation capacity when the vehicle is driven on the electric machine, the applicant has combined the variable-speed transmission with another epicyclic gear train connecting the engine epicyclic gear train to a transmission track for motion transmission to the drive axle of the vehicle, as described in French patent application No. 2,962,697 filed by the applicant.

Thus, the speed transmission device described in the aforementioned applications allows three forward speed ratios of the vehicle with the thermal engine and two speed ratios in forward or reverse gear.

With a view to continuous improvement, the applicant has further enhanced this variable-speed transmission by making it possible for the vehicle to be driven on the thermal engine with an additional speed ratio.

With this speed ratio, the thermal engine is used over a better operating point while having a higher wheel torque.

### SUMMARY OF THE INVENTION

The invention therefore relates to a powertrain for a hybrid type motor vehicle comprising a driving/receiving machine, a thermal engine, a speed variation device including an engine epicyclic gear train with a sun gear and a crown, each connected to the engine shaft by a controlled clutch and to a fixed part of the powertrain by a one-way clutch and a planet gear carrier, another machine epicyclic gear train comprising a sun gear, a crown and a planet gear carrier connected to a device for motion transmission to a drive axle, and a rotating motion transmission track for the link between the engine shaft and the motion transmission device. The motion transmission track comprises a controlled link between the engine shaft and at least one of the elements of one of the epicyclic gear trains.

The element can be the sun gear or the planet gear carrier or the crown of the machine epicyclic gear train.

The element can be the planet gear carrier of the engine epicyclic gear train.

The controlled link can comprise a controlled clutch.

The controlled link can comprise a claw.

The controlled link can comprise a one-way automatic clutch.

The controlled link can comprise a free wheel.

The transmission track can comprise two half shafts connected to one another by a one-way automatic clutch.

One of the half shafts can be connected to the engine shaft and the other half shaft can be connected to the controlled clutch.

One of the half shafts can be connected to the engine shaft and the other half shaft can be connected to an element of one of the epicyclic gear trains.

The other half shaft can be connected to the planet gear carrier of the engine epicyclic gear train.

The transmission track can comprise a wheel carrying teeth connected to the engine shaft by the one-way automatic clutch and to a wheel carrying teeth connected to the crown of the machine epicyclic gear train.

### BRIEF DESCRIPTION OF THE DRAWINGS

Other features and advantages of the invention will be clear from reading the description hereafter, given by way of non limitative example, with reference to the accompanying figures wherein:

FIG. 1 is a diagram showing a powertrain using a variable-speed transmission device according to the invention;

FIG. 2 diagrammatically illustrates a variant of the powertrain of FIG. 1;

FIG. 3 shows a variant of the powertrain of FIG. 2; and

FIG. 4 is another variant of the powertrain of FIG. 2.

### DETAILED DESCRIPTION OF THE INVENTION

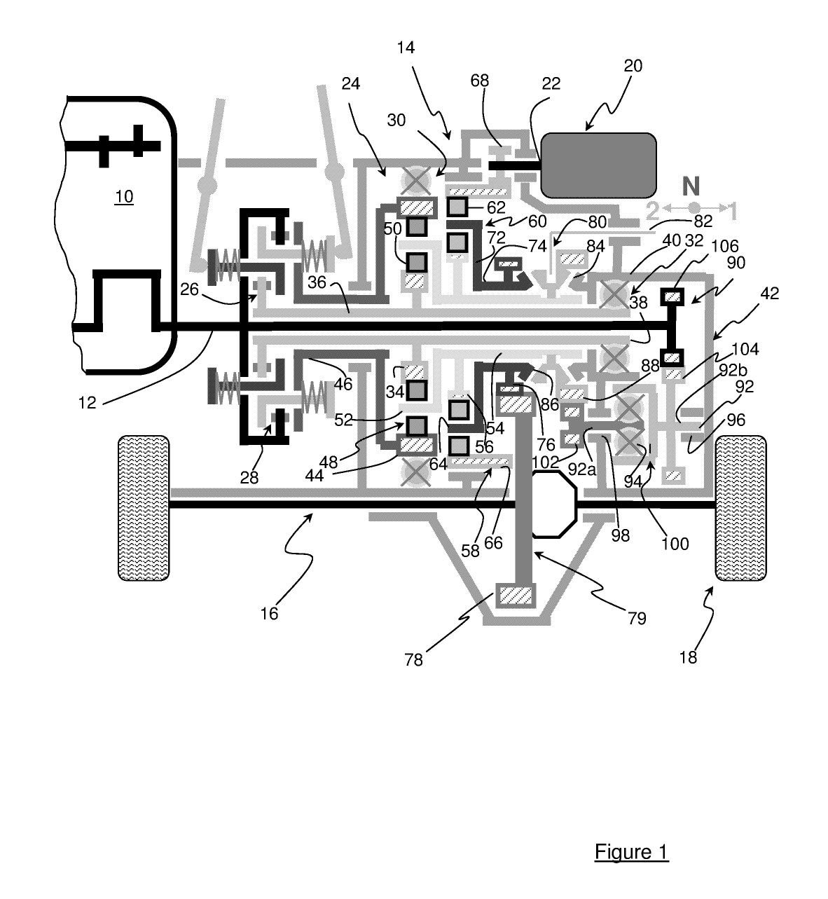

In FIG. 1, the powertrain comprises a thermal engine 10, notably an internal-combustion engine, with an engine shaft 12, coming from the crankshaft of the engine, and a variable-speed device 14 transmitting motion to a drive axle 16 for driving the driving wheels 18 of the vehicle.

Engine shaft 12 also functions as a receiving shaft but, for description simplification reasons, this shaft is referred to as engine shaft to distinguish it from the other shafts of the transmission.

The powertrain also comprises a driving/receiving machine, such as an electric motor 20 with a rotor 22, that can be used as an electric motor for driving the vehicle by connection to an electric power source, such as batteries (not shown) or to an electric power generator and, more particularly, as an alternator for charging these batteries.

Speed variation device 14 comprises a main epicyclic gear train 24, referred to as thermal engine epicyclic gear train, with two controlled clutches 26, 28, here in form of friction clutches, and two one-way automatic clutches, such as free wheels 30, 32.

More precisely, engine epicyclic gear train 24 comprises a sun gear wheel 34 fixedly carried by a hollow shaft 36, referred to as sun gear shaft, which caps engine shaft 12 while being free to rotate but fixed in translation with respect thereto. Free end 38 of this hollow shaft rests on a bearing 40 carried by a fixed element 42 of the powertrain through free wheel 32, referred to as sun gear free wheel, which allows rotation of the sun gear in only one direction.

This gear train also comprises a crown toothed wheel 44 arranged concentric to the sun gear, and fixedly connected to a hollow shaft 46, referred to as crown shaft, surrounding sun gear hollow shaft 36 while being free to rotate, but fixed in translation with respect thereto. This crown is externally connected to fixed element 42 of the vehicle powertrain by one-way clutch 30, referred to as crown free wheel, which allows rotation of the crown in only one direction.

Of course, the two free wheels 30 and 32 are arranged in such a way that sun gear 34 and crown 44 can rotate only in the same direction, and preferably in the same direction as engine shaft 12.

Finally, this engine epicyclic gear train comprises a planet gear carrier 48 with advantageously three planet gears 50 in form of wheels with external teeth arranged in the same angular interval with respect to one another (120° here) and meshing with the crown and the sun gear.

Sun gear 34, crown 44 and planet gears 50 are therefore arranged in the same plane, here in a vertical plane of FIG. 1.

The planet gears are carried each by a horizontal pin 52 while being free to rotate, but are fixed in translation thereon. These planet gear pins are connected to a tubular shaft 54, referred to as planet gear carrier shaft, surrounding sun gear shaft 36 while free to rotate thereon.

The free ends of the sun gear and crown shafts carry each a controlled clutch 26 and 28, preferably a friction clutch controlled each by a lever control.

Thus, clutch 26, referred to as sun gear clutch, allows coupling of sun gear 34 with engine shaft 12 while the purpose of clutch 28, referred to as crown clutch, is to allow coupling of crown 44 to the engine shaft.

As is more visible in FIG. 1, planet gear carrier shaft 54 fixedly carries a sun gear wheel 56 of an additional epicyclic gear train 58, referred to as machine epicyclic gear train in the rest of the description.

This machine epicyclic gear train 58, which is coaxially arranged to engine epicyclic gear train 24 on engine shaft 12, comprises a planet gear carrier 60 with advantageously three planet gears 62, in the form of wheels with external teeth, carried by planet gear pins 64, arranged in the same angular interval with respect to one another (120° here) and meshing with sun gear 56. These planet gears also cooperate by meshing with a crown wheel with teeth 66 that meshes with a wheel 68 carrying teeth fixedly carried by rotor 22 of electric machine 20.

Of course, like thermal engine epicyclic gear train 24, sun gear 56, planet gears 62 and crown 66 are arranged in the same plane, here in a vertical plane relative to FIG. 1.

Planet gear pins 64 are carried by a plate 72 comprising a tubular bearing 74 surrounding freely in rotation but fixedly in translation on tubular shaft 54 of the planet gear carrier. This tubular bearing also fixedly carries a wheel 76 with teeth that cooperates with a wheel 78 with teeth linked to axle 16.

This assembly of two wheels 76 and 78 with teeth thus forms a motion transmission 79 between machine epicyclic gear train 58 and axle 16.

Planet gear carrier shaft 54 of the machine epicyclic gear train also carries a controlled double-effect clutch 80 that is fixed in rotation on this shaft but free to translate under the action of a control 82.

By way of example, this clutch is a claw that can cooperate with either a supplementary coupling surface 84 provided on fixed element 42 of the powertrain (position 1), or with another supplementary coupling surface 86 arranged at the end of tubular bearing 74 of planet gear carrier 60 (position 2). This claw also fixedly carries a wheel 88 with teeth whose purpose is detailed in the description below.

This claw thus forms a controlled link between engine shaft 12 and at least one of the elements of machine epicyclic gear train 58, here planet gear carrier 60 and/or sun gear 56.

This powertrain also comprises a rotating motion transmission track 90 for the link between engine shaft 12 and motion transmission device 79 to allow the vehicle to be driven on the thermal engine with an additional fourth speed ratio, as explained below.

This rotating motion transmission track comprises a rotating motion transmission shaft 92 substantially parallel to engine shaft 12. This shaft is advantageously made up of two parts 92a and 92b (or half shafts) connected to one another by a one-way clutch 94, here in form of a free wheel. Each half shaft 92a, 92b is carried by a bearing 96, 98 respectively, coming from a fixed part 42 of the powertrain. The end of one of the half shafts carries a cage 100 in which the free wheel is arranged, while the free end of the other half shaft rests against the inside diameter of this free wheel.

This allows simultaneous rotation of the two half shafts in only one direction of rotation.

Half shaft 92a carries, on its end pointed at engine 10, a fixed wheel 102 with teeth that cooperates with wheel 88 with teeth carried by claw 80. The other half shaft 92b carries, at its end opposite cage 100, a fixed wheel 104 with teeth that meshes with a fixed wheel 106 with teeth carried by shaft 12.

Thus, motion transmission track 90 comprises wheel 106 with teeth of engine shaft 12, the two half shafts 92a and 92b associated with free wheel 94 and with wheels 104 and 102 with teeth, toothed wheel 88 with teeth of the claw and claw 80.

This track thus comprises a link between engine shaft 12 and the tubular bearing of the planet gear carrier carrying wheel 76 with teeth that is controlled by claw 80.

The various configurations of the vehicle drive by the powertrain are now described according to the traction/propulsion mode used.

For simplification reasons, only the configurations with traction/propulsion by the thermal engine or by the electric motor are mentioned, the other configurations have already been explained in the aforementioned patent applications filed by the applicant.

When the vehicle is driven by electric motor 20, both clutches 26 and 28 are inactive.

In position 1 of claw 80 that cooperates with coupling surface 84 of fixed element 42, sun gear 56 of gear train 58 and planet gear carrier 48 of gear train 24 are immobilized in rotation.

As soon as electric motor 20 is powered, its rotor 22 is driven in rotation. This rotating motion is transmitted to crown 66 of epicyclic gear train 58, then to planet gears 62 and to planet gear carrier 60, and eventually to axle 16 through motion transmission device 79.

In position 2 of claw 80 that cooperates with coupling surface 86 of bearing 74, sun gear 56 of gear train 58 and planet gear carrier 48 of gear train 24 are connected to planet gear carrier 60 of gear train 58. The rotation of crown 66 is thus transmitted to the assembly having of planet gear carrier 60 and sun gear 56. The rotation of this assembly is retransmitted to toothed wheel 76 that cooperates with axle toothed wheel 78 by thus driving the wheels of the vehicle in rotation.

The other configurations are described now to illustrate traction/propulsion of the vehicle by thermal engine 10 according to different speed ratios.

In these configurations, claw 80 is either in neutral position for speed ratios 1 to 3, or in position 2 for speed ratio 4. Clutches 26 and 28 are both inactive for speed ratio 1, and these clutches are either both in active position, or one or the other is in active position for speed ratios 2 to 4.

As regards speed ratio 1, clutches 26 and 28 are in inactive position and the claw is in position 2.

The rotating motion of shaft 12 of engine 10 is transmitted to half shaft 92b by the gear made up of wheels 106 and 104 with teeth. This rotating motion of this half shaft is then transferred to the other half shaft 92a through free wheel 94 that is then active so as to drive this other half shaft in the same direction of rotation. The rotation of this half shaft is transmitted to wheel 88 with teeth of claw 80 by wheel 102 with teeth and to hollow shaft 54.

The rotation of wheel 88 with teeth is then transmitted to the shaft of the planet gear carrier carrying sun gear 56 of gear train 58, then to planet gear carrier 60 of this gear train through surface 86 rotating at the same speed.

As described above, this configuration involves the same motion transmission path from the planet gear carrier to motion transmission device 79 and axle 16.

When the claw is in position 2, the rotation of wheel 88 with teeth is transmitted to the shaft of the planet gear carrier carrying sun gear 56 of gear train 58, then to planet gear carrier 60 of this gear train, which then rotates at the same speed.

Similarly, as mentioned above, this configuration involves the same motion transmission path from the planet gear carrier/sun gear assembly to motion transmission device 79 and axle 16.

For the active position of clutch 26 and inactive position of clutch 28 of speed ratio 2, the rotation of shaft 12 of thermal engine 10 drives sun gear 34 to rotate. The rotation of the sun gear drives in turn in rotation planet gear carrier 48 with its planet gear carrier shaft 54. The planet gear carrier shaft drives sun gear 56 in rotation of the other epicyclic gear train 58 through shaft 54. This sun gear then drives planet gear carrier 60 of this gear train 58. The planet gear carrier then drives axle 16 through wheels 76 and 78 of motion transmission device 79, claw 80 being in position 2.

For the active position of clutch 28 and inactive position of clutch 26 (speed ratio 3), the rotation of shaft 12 of thermal engine 10 drives in rotation crown 44 that drives in rotation planet gear carrier 48. This rotation of the planet gear carrier is then transmitted to sun gear 56 of machine epicyclic gear train 58 by shaft 54. The sun gear then drives planet gear carrier 60 of this gear train 58 with transmission of the rotating motion to the axle as mentioned above.

In the configuration where clutches 26 and 28 are both in active position for speed ratio 4, the rotation of shaft 12 of thermal engine 10 drives crown 44 to rotate, sun gear 34 and consequently planet gear carrier 48 of engine epicyclic gear train 24. The rotation of the planet gear carrier is then transmitted to sun gear 56 of the other epicyclic gear train 58 by shaft 54. This sun gear drives in turn planet gear carrier 60 of this gear train 58 to rotate through claw 80 and surface 86. The planet gear carrier then drives axle 16 through wheels 76 and 78 of motion transmission device 79 with claw 80 being in position 2.

Simultaneously, the rotation of planet gear carrier shaft 54 is transmitted to half shaft 92a through meshing of wheel 88 with teeth of the claw with wheel 102 with teeth of half shaft 92a but, due to the presence of free wheel 94, this rotation is not retransmitted to half shaft 92b.

A speed ratio 1 is thus obtained with the inaction of clutches 26 and 28, a speed ratio 2 through the action of clutch 26, a speed ratio 3 through the action of clutch 28 and a speed ratio 4 with the simultaneous action of clutches 26 and 28.

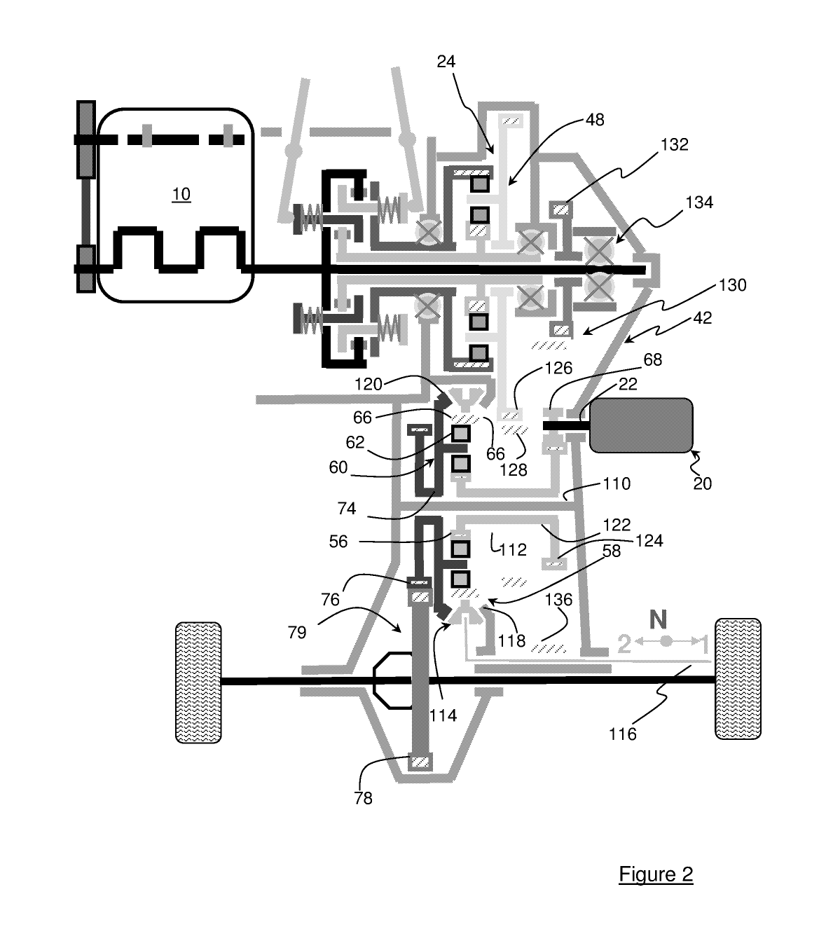

The variant of FIG. 2 differs from FIG. 1 in the parallel arrangement of the two epicyclic gear trains 24 and 58, as already described in patent application No. 2,962,697 filed by the applicant, and in the controlled link with one of the elements of machine epicyclic gear train 58, here crown 66.

This powertrain comprises an engine epicyclic gear train 24 similar to that of FIG. 1 and a machine epicyclic gear train 58 arranged on another shaft.

Epicyclic gear train 58 is arranged on a fixed shaft 110, substantially parallel to engine shaft 12, while being carried by fixed element 42 of the powertrain.

The machine epicyclic gear train comprises a sun gear wheel 56 with teeth, a planet gear carrier 60 with advantageously three planet gears 62 and a crown wheel 66 with teeth.

The planet gear carrier comprises a tubular bearing 74 surrounding freely in rotation but fixedly in translation shaft 110. This tubular bearing also fixedly carries a wheel 76 with teeth that cooperates with a wheel 78 with teeth linked to axle 16.

Of course, like thermal engine epicyclic gear train 24, sun gear 56, planet gears 62 and crown 64 are arranged in the same plane, here in a vertical plane considering FIG. 1.

This assembly of toothed wheels 76 and 78 with teeth thus forms a motion transmission device 79 between machine epicyclic gear train 58 and axle 16.

Crown 66 carried by a crown shaft 112 also comprises a controlled double-effect clutch 114 of claw type carried fixedly in rotation by this crown while being mobile in axial translation thereon.

This claw is operated by a control 116 allowing two meshing positions (1, 2) and a neutral position (N) to be obtained. This claw is intended to cooperate with either a fixed coupling surface 118 carried by a fixed element 42 of the powertrain, or with another coupling surface 120 carried by planet gear carrier 60.

Thus, under the action of control 116, the claw can achieve coupling of crown 66 with fixed element 42 (position 1), with planet gear carrier 60 (position 2) or be in neutral position (position N) without being linked with any of the two coupling surfaces.

Sun gear 56 is carried by a sun gear shaft 118 that comprises a fixed wheel 124 with teeth meshing with wheel 68 with teeth carried by rotor 22 of motor 20.

As is more visible in FIG. 2, the rotational link between the two gear trains is provided by the cooperation of two wheels 126 and 128 with teeth. One of these wheels, 126, is carried by planet gear carrier 48 of engine epicyclic gear train 24 and the other wheel, 128, is carried by shaft 112 of crown 66 of machine epicyclic gear train 58.

Motion transmission track 130 comprises a wheel 132 with teeth which freely rotates but is fixed in translation, carried by engine shaft 12 through a one-way automatic clutch 134, a free wheel here, which provides controlled link with this wheel, a wheel 136 with teeth carried by crown shaft 112 and crown 66 carrying claw 114.

The operation of this variant for speed ratios 2 to 4 for traction/propulsion of the vehicle by thermal engine 10 is similar to those previously described with claw 114 in neutral position or position 2, and clutches 26 and 28 either both in active position or one or the other in active position according to different speed ratios.

In these speed ratios, the rotation of engine shaft 12 is not retransmitted to toothed wheel 132 because free wheel 134 is not made operational, the rotating speed of wheel 134 with teeth is higher than the rotating speed of shaft 112. This rotating speed is obtained by the number of teeth of wheels 126, 128, 136 and 132.

For speed ratio 1, both clutches are inactive and claw 114 is in position N or 2.

As soon as engine shaft 12 reaches a sufficient rotating speed, the free wheel is active by driving in rotation wheel 132 with teeth. This rotation is subsequently transmitted to wheel 130 with teeth, then to crown 66.

When claw 114 is in neutral position N, the rotation of crown 66 is transmitted to planet gear carrier 60 of this gear train and to sun gear 56 through the agency of planet gears 62.

The rotation of this planet gear carrier 60 is subsequently transmitted to motion transmission device 79 that then drives axle 16 through the agency of wheels 76 and 78.

When the claw is in position 2, crown 66 and planet gear carrier 60 are locked together and they then rotate at the same speed.

The rotation of this planet gear carrier/crown assembly allows driving in rotation axle 16 through motion transmission device 79 with wheels 76 and 78.

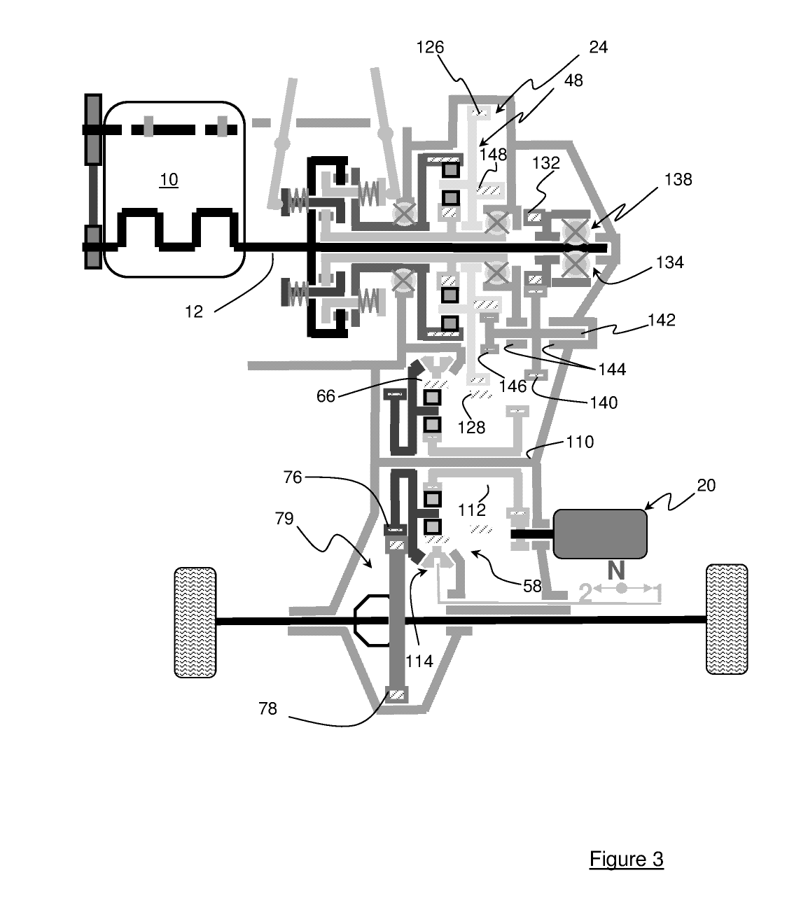

The variant of FIG. 3 differs from FIG. 2 in the configuration of the transmission track that comprises the controlled link.

As in FIG. 2, the rotational link of FIG. 3 between the two gear trains 24 and 58 is provided by the cooperation of two wheels 126 and 128 with teeth. One of these wheels, 126, is carried by planet gear carrier 48 of engine epicyclic gear train 24 and the other wheel, 128, is carried by shaft 112 of crown 66 of machine epicyclic gear train 58.

Motion transmission track 130 comprises wheel 132 with teeth which is carried by engine shaft 12 through free wheel 134, which provides a controlled link between the shaft and this wheel.

This transmission track differs from that of FIG. 2 in that wheel 132 with teeth meshes with a wheel 140 with teeth carried by an intermediate shaft 142 substantially parallel to engine shaft 12. This shaft which is fixed in translation but free in rotation on fixed bearings 144 of element 42, also carries another wheel 146 with teeth that meshes with a wheel 148 with teeth carried by planet gear carrier 48 of gear train 24.

Thus, the motion transmission track comprises wheel 132 with teeth, free wheel 134, which provides controlled link between engine shaft 12 and this wheel, wheels 140 and 146 with teeth carried by intermediate shaft 142, wheel 148 carried by planet gear carrier 48, wheel 126 with teeth also carried by planet gear carrier 48, wheel 128 carried by crown shaft 112 and crown 66 carrying claw 114.

The operation of this variant for traction/propulsion of the vehicle by thermal engine 10 or by electric motor 20 is similar to those previously described in connection with FIG. 2.

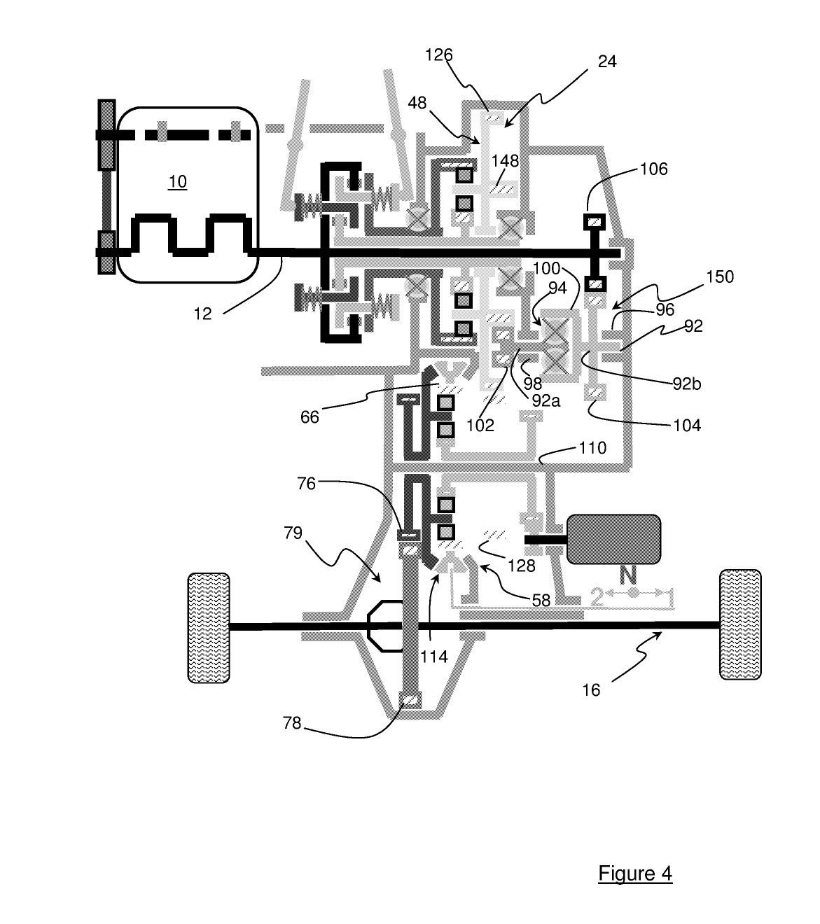

The variant of FIG. 4 takes up part of the configuration of FIG. 1 and part of the configuration of FIG. 2.

Thus, the powertrain comprises an engine epicyclic gear train 24 arranged on an engine shaft 12 and a machine epicyclic gear train 58 arranged on another shaft 110, similar to those of FIG. 2, and a motion transmission device 79 between machine epicyclic gear train 58 and axle 16, which is made up of wheels 76 and 78 with teeth.

Besides, as for the variant of FIG. 3, the rotational link between the two gear trains is provided by the cooperation of the two wheels 126 and 128 with teeth.

This powertrain furthermore comprises a rotating motion transmission track 150 for the link between engine shaft 12 and motion transmission device 79, which allows the vehicle to be driven on the thermal engine according to an additional speed ratio (ratio 1).

This rotating motion transmission track, close to that of FIG. 1, comprises a rotating motion transmission shaft 92 substantially parallel to engine shaft 12. This shaft advantageously consists of two parts 92a and 92b (or half shafts) connected to one another by a free wheel 94. Each half shaft 92a, 92b is carried by a fixed bearing 96, 98 respectively, coming from a fixed part 42 of the powertrain. The end of one of the half shafts carries a cage 100 in which free wheel 94 is arranged, while the free end of the other half shaft rests on the inside diameter of this free wheel.

Free wheel 94 thus allows achieving a controlled link between the two half shafts.

Half shaft 92a carries, on its end pointed at engine 10, a fixed wheel 102 with teeth that cooperates with wheel 148 with teeth carried by planet gear carrier 48 of engine epicyclic gear train 24. The other half shaft 92b carries, at its end opposite cage 100, a fixed wheel 104 with teeth that meshes with a fixed wheel 106 with teeth carried by shaft 12.

Thus, motion transmission track 150 comprises wheel 106 with teeth of engine shaft 12, the two half shafts 92a and 92b associated with free wheel 94 allowing a controlled link to be achieved, wheels 02 and 104 with teeth, wheel 148 carried by planet gear carrier 48, wheel 126 with teeth also carried by planet gear carrier 48, wheel 128 carried by crown shaft 112 and crown 66 carrying claw 114.

The operation of this variant for traction/propulsion of the vehicle by thermal engine 10 or by electric motor 20 is similar to those previously described in connection with FIG. 2, with the specific feature that free wheel 94 fulfils a controlled link function as described in FIG. 2.

1-15. (canceled)

16. A powertrain for a hybrid type motor vehicle comprising a driving/receiving machine, a thermal engine, a speed variation device including an engine epicyclic gear train with a sun gear and a crown, each connected to engine shaft by a controlled clutch and to a fixed part of the powertrain by a one-way clutch and a planet gear carrier, another machine epicyclic gear train comprising a sun gear, a crown and a planet gear carrier connected to a device for motion transmission to a drive axle, and a rotary motion transmission track for the link between the engine shaft and the motion transmission, wherein rotary motion transmission track comprises a controlled link between the engine shaft and at least one element of one of the epicyclic gear trains.

17. A powertrain as claimed in claim 16, wherein the at least one element is sun gear of the another machine epicyclic gear train.

18. A powertrain as claimed in claim 16, wherein the at least one element is planet gear carrier of the machine epicyclic gear train.

19. A powertrain as claimed in claim 16, wherein the at least one element is the crown of machine epicyclic gear train.

20. A powertrain as claimed in claim 16, wherein the at least one element is planet gear carrier of the engine epicyclic gear train.

21. A powertrain as claimed in claim 16, wherein the controlled link comprises a controlled clutch.

22. A power train as claimed in claim 17, wherein the controlled link comprises a controlled clutch.

23. A power train as claimed in claim 18, wherein the controlled link comprises a controlled clutch.

24. A power train as claimed in claim 19, wherein the controlled link comprises a controlled clutch.

25. A power train as claimed in claim 20, wherein the controlled link comprises a controlled clutch.

26. A power train as claimed in claim 21, wherein the controlled link comprises a claw.

27. A power train as claimed in claim 16, wherein the controlled link comprises a one-way automatic clutch.

28. A power train as claimed in claim 17, wherein the controlled link comprises a one-way automatic clutch.

29. A power train as claimed in claim 18, wherein the controlled link comprises a one-way automatic clutch.

30. A power train as claimed in claim 19, wherein the controlled link comprises a one-way automatic clutch.

31. A power train as claimed in claim 20, wherein the controlled link comprises a one-way automatic clutch.

32. A power train as claimed in claim 27, wherein the controlled link comprises a free wheel.

33. A power train as claimed in claim 28, wherein the controlled link comprises a free wheel.

34. A power train as claimed in claim 29, wherein the controlled link comprises a free wheel.

35. A power train as claimed in claim 30, wherein the controlled link comprises a free wheel.

36. A power train as claimed in claim 31, wherein the controlled link comprises a free wheel.

37. A powertrain as claimed in claim 16, wherein the transmission track comprises two half shafts connected to one another by a one-way automatic clutch.

38. A powertrain as claimed in claim 37, wherein one of the half shafts is connected to engine shaft and the other half shaft is connected to controlled clutch.

39. A powertrain as claimed in claim 37, wherein one of the half shafts is connected to engine shaft and the other half shaft is connected to an element of one of epicyclic gear trains.

40. A powertrain as claimed in claim 39, wherein the other half shaft is connected to planet gear carrier of engine epicyclic gear train.

41. A powertrain as claimed in claim 16, wherein transmission track comprises a wheel with teeth connected to engine shaft by a one-way automatic clutch and to a wheel with teeth connected to crown of machine epicyclic gear train.

42. A powertrain as claimed in claim 16, wherein transmission track comprises a wheel with teeth connected to engine shaft by a one-way automatic clutch and to a wheel with teeth connected to planet gear carrier of machine epicyclic gear train by a wheel with teeth.
